(19) United States
(12) Patent Application Publication
(10) Pub. No.: US 2008/0143557 A1
(43) Pub. Date: Jun. 19, 2008

(54) SYSTEM AND METHOD FOR CONVEYING A GATE ASSIGNMENT TO AN AIR CREW

(75) Inventor: Robert P. Smith, Clinton, WA (US)

Correspondence Address: LAW OFFICE OF DONALD D. MONDUL, 3060 BONSAI DRIVE, PLANO, TX, 75093, US

(73) Assignee: BOEING COMPANY, A CORPORATION OF DELAWARE, Chicago, IL (US)

(21) Appl. No.: 11/611,940

(22) Filed: Dec. 18, 2006

(51) Int. Cl. G08G 5/00

(52) U.S. Cl. 340/958

(57) ABSTRACT

A system for conveying a gate assignment at an airfield to an air crew in an aircraft includes: (a) a ground station; (b) a mobile station carried with the aircraft and configured for communicative coupling with the ground station; and (c) a display unit carried with the aircraft and coupled with the mobile station. The ground station transmits the gate assignment to the mobile station. The display unit receives the gate assignment from the mobile station and presents a graphic representation of the gate assignment to the air crew.

### BACKGROUND

A system and method for displaying gate information, such as by way of example and not by way of limitation an assigned gate for debarking passengers, may provide supplementary position awareness for air crews (also sometimes referred to as flight crews) during preparation for and execution of operations prior to landing, during landing and during taxiing on the ground. The system and method may promote efficient and safe operations by reducing air crew workload and error potential. In particular, the system and method of the present invention may remove a need for a pilot's (or other air crew member's) noting of assigned gate information on random pieces of paper scattered throughout the cockpit or by relying on one's memory.

During approach planning prior to landing a flight crew may plan their arrival at an airport based on an expected landing runway that will be used. Arrival direction may be correlated with the landing runway orientation for top-of-descent planning and for anticipated taxiing or other maneuvering to reach an assigned locus, such as a gate or a terminal for parking. The term gate assignment and variations of that term are intended in this disclosure to include parking assignments at terminal gates, at outlying terminals, at outlying spots removed from terminals or at any other locus designated for parking an aircraft whether a passenger aircraft, a cargo aircraft or another aircraft.

Prior art systems and methods communicate parking gate assignment information to an aircraft using voice message or data link technology. This gate information is usually communicated to the aircraft just prior to beginning a descent to approach an airport or during the descent for approach. Pilots or other air crew members in the cockpit of the aircraft often print the data link message or write the assigned parking position (whether received verbally or via data link) on another piece of paper for future reference. Once the available landing runway and parking gate position are known, that information may be employed for arrival planning. Arrival planning may require that the pilot or another air crew member find and view the parking gate information and then retrieve the airport chart to correlate the two pieces of data: runway information and gate assignment. The chart is often stowed in a chart book or EFB (Electronic Flight Bag) so that one is required to turn one's attention from other tasks to carry out the required data correlation. Based on the gate position assignment the pilot may plan and request a specific runway for landing or may anticipate a taxi route from an assigned arrival runway to the parking gate position. Once on the ground, the pilot or another air crew member may confirm the parking gate position by voice communication with a ground station such as station operations. It is possible that the parking gate position may have changed from the position that was initially assigned so that the process of positional awareness must be repeated with respect to runways and gate position assignment. By way of example and not by way of limitation, if the parking gate assignment changes during taxi, the pilot or another air crew member must locate the new parking gate position and determine whether a change in previously determined ATC (Air Traffic Control) routing is required.

During departure, once an aircraft has departed from its gate, the aircraft will normally proceed to an active runway (usually assigned by the time the aircraft leaves the gate). However, it is possible that the aircraft will have to return to its previously assigned gate or to another parking gate position. Occasions for such a return to a gate include, by way of example and not by way of limitation, for mechanical repairs or to take care of a customer service request. When an aircraft must return to a gate a parking gate position will usually be assigned by a ground station operations entity. As in the case of arrival, the pilot or another air crew member will need to correlate the current position of the aircraft with the newly assigned gate position.

There is a need for a system and method for conveying a gate assignment to an air crew that does not require special measures by air crew members to preserve the information, such as by printing or writing down the information.

It is preferred that the system and method for conveying a gate assignment to an air crew employ a graphic display for one or more of the air crew members.

The system and method for conveying a gate assignment to an air crew may be configured to change scale of the graphic display as the distance between the aircraft and the airport changes.

### SUMMARY

A system for conveying a gate assignment at an airfield to an air crew in an aircraft includes: (a) a ground station; (b) a mobile station carried with the aircraft and configured for communicative coupling with the ground station; and (c) a display unit carried with the aircraft and coupled with the mobile station. The ground station transmits the gate assignment to the mobile station. The display unit receives the gate assignment from the mobile station and presents a graphic representation of the gate assignment to the air crew.

A method for conveying a gate assignment at an airfield to an air crew in an aircraft includes, (a) in no particular order: (1) providing a ground station; (2) providing a mobile station carried with the aircraft; and (3) providing a display unit carried with the aircraft; (b) operating the ground station and the mobile station to effect communicatingly conveying the gate assignment between the ground station and the mobile station; and (c) operating the display unit to receive the gate assignment from the mobile station and present a graphic representation of the gate assignment to the air crew.

It is, therefore, a feature of the disclosure to provide a system and method for conveying a gate assignment to an air crew that does not require special measures by air crew members to preserve the information, such as by printing or writing down the information.

It is preferred that a feature of the disclosure provide a system and method for conveying a gate assignment to an air crew that employs a graphic display for one or more of the air crew members.

It is further preferred that a feature of the disclosure provide a system and method for conveying a gate assignment to an air crew may be configured to change scale of the graphic display as the distance between the aircraft and the airport changes.

Further features of the disclosure will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic diagram illustrating the system of the disclosure.

FIG. 2 is a flow chart illustrating the method of the disclosure.

### DETAILED DESCRIPTION

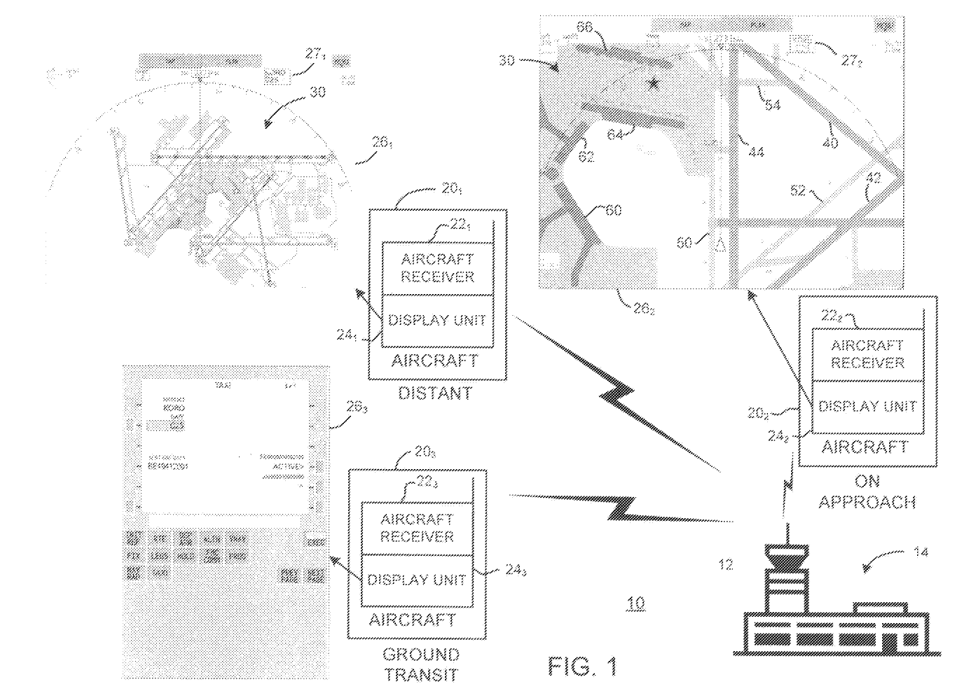

FIG. 1 is a schematic diagram illustrating the system of the disclosure. In FIG. 1, a system 10 for conveying a gate assignment to an aircrew in an aircraft may include a ground station 12, preferably located at a ground control facility 14 such as an airport tower. An aircraft 20 is illustrated in FIG. 1 at three representative orientations with respect to ground station 12. Aircraft representation 20₁ may represent an aircraft 20 at a distant range, prior to or just ready to commence a landing approach at the airport (not represented in detail in FIG. 1) served by ground station 12. Aircraft 20 may include an aircraft receiver unit 22. Aircraft receiver unit 22 is illustrated in FIG. 1 at three representative orientations with respect to ground station 12 substantially conforming with the three orientations associated with aircraft 20. Aircraft receiver unit 22₁ may represent a receiver unit 22 at a distant range, prior to or just ready to commence a landing approach at the airport served by ground station 12.

Aircraft 20 may also include a display unit 24. Display unit 24 may present a graphic display 26. Aircraft display unit 24 and graphic display 26 are illustrated in FIG. 1 at representative orientations with respect to ground station 12 substantially conforming with the orientations associated with aircraft 20. Aircraft display unit 24, may represent a display unit 24 presenting a graphic display 26₁ at a distant range, prior to or just ready to commence a landing approach at the airport served by ground station 12.

Information identifying a gate C25 as the assigned gate for aircraft 20 may be communicated from ground station 12 via aircraft receiver 22. Display unit 24 may receive the information from receiver unit 22. Graphic display 26 may receive the information from receiver unit 22 and may present the information in graphic display 26, such as by way of example and not by way of limitation by an identifying icon or indicator. In graphic display 26 assigned gate C25 is indicated by a star (“⋆”). Other indicators or icons may be used as desired and still remain within the scope of the present invention. An example of such an other indicator is an identifying box 27 indicating airport and gate as: “KORD C25”. The identifying indicator related with gate C25 may convey gate assignment information to an air crew in an aircraft employing system 10 without requiring that an air crew member employ any special measures to preserve the gate assignment information, such as by printing or writing down the information. An embodiment of the invention may involve a user, such as an air crew member, initiating an action such as pushing a button or switch to effect accepting the gate assignment information for display.

As mentioned earlier herein, graphic display 26₁ may be presented when aircraft 20₁ is situated at a distant locus with respect to ground station 12. Graphic display 26₁ may be a generally large scale representation of an airport 30 illustrating features of airport 30 that are familiar to those skilled in the art of graphic displays, such as by way of example and not by way of limitation landing strips, taxi-ways and terminal buildings. Features of airport 30 will not be described or labeled in detail in graphic display 26₁ in order to avoid cluttering graphic display 26₁. However, an assigned gate C25 may be indicated in graphic display 26₁ by an identifying icon or indicator. In graphic display 26₁ assigned gate C25 is indicated by a star (“⋆”). The scale of graphic display 26₁ is preferably appropriate to permit an air crew member to consider location of assigned gate position C25 when selecting a preferred landing runway for an approach to airport 30.

Aircraft representation 20₂ may represent an aircraft 20 at a middle range less than the range represented in connection with aircraft representation 20₁ (described above). The middle range associated with aircraft representation 20₂ may be during a landing approach at the airport served by ground station 12. Aircraft 20₂ may include an aircraft receiver unit 22₂ and a display unit 24₂. Display unit 24₂ may present a graphic display 26₂. Graphic display 26₂ may be presented when aircraft 20₂ is at a middle range such as during a landing approach at the airport served by ground station 12.

Information identifying a gate C25 as the assigned gate for aircraft 20₂ may continue to be communicated from ground station 12 via aircraft receiver 22₂. Display unit 24₂ may receive the information from receiver unit 22₂ and may present the information in graphic display 26₂, such as by way of example and not by way of limitation by an identifying icon or indicator. In graphic display 22₂ assigned gate C25 is indicated by a star (“⋆”). Other indicators or icons may be used as desired and still remain within the scope of the present invention. An example of such an other indicator is an identifying box 29 indicating airport and gate as: “KORD C25”. The identifying indicator relating with gate C25 may convey gate assignment information to an air crew in an aircraft employing system 10 without requiring that an air crew member employ any special measures to preserve the gate assignment information, such as by printing or writing down the information. An embodiment of the invention may involve a user, such as an air crew member, initiating an action such as pushing a button or switch to effect accepting the gate assignment information for display.

As mentioned earlier herein, graphic display 26₂ may be presented when aircraft 20₂ is situated at a middle range locus with respect to ground station 12. As distance between aircraft 20 and ground station 12 varies, the scale of graphic display 26 preferably may change so graphic display 26₂ may be configured at a scale smaller than graphic display 26₁. Graphic display 26₂ may thus illustrate significant detail of features of airport 30 such as by way of example and not by way of limitation landing strips 40, 42, 44; taxi-ways 50, 52, 54 and terminal buildings 60, 62, 64, 66. Assigned gate C25 may be located at terminal 66 as indicated by an identifying icon or indicator. In graphic display 26₂ assigned gate C25 is indicated by a star (“⋆”). The scale of graphic display 26₂ is preferably appropriate to permit an air crew member to consider location of assigned gate position C25 when selecting a preferred landing runway for an approach to airport 30.

Graphic display 26₂ may convey gate assignment information to an air crew in an aircraft employing system 10 without requiring that an air crew member employ any special measures to preserve the gate assignment information, such as by printing or writing down the information. An embodiment of the invention may involve a user, such as an air crew member, initiating an action such as pushing a button or switch to effect accepting the gate assignment information for display. The smaller scale of graphic display 26₂ as compared with the scale of graphic display 26₁ may permit conveying more detailed information to an air crew, such as sufficient detail to decide upon a desirable taxi route to assigned gate C25. The scales of graphic displays 26₁, 26₂ may be selected manually by a user, such as an air crew member.

Aircraft representation 20₃ may represent an aircraft 20 at any range. By way of example and not by way of limitation, a graphic display 26₃ is characterized in FIG. 1 as a Command Display Unit (CDU) of a sort familiar to those skilled in the art of aircraft operation, such as air crew members. In embodiments employing action by a user, such as an air crew member, to effect display of gate assignment information by a display unit, a CDU may be an instrument by which an air crew member may initiate such an action. Such an action may be initiated, by way of example and not by way of limitation, by pushing a button or switch on a CDU, or entering data using a keyboard or employing another input device to effect display of gate assignment information by a display unit.

Information identifying a gate C25 as the assigned gate for aircraft 20₃ may continue to be communicated from ground station 12 via aircraft receiver 22₃. Display unit 24₃ may receive the information from receiver unit 22₃ and may present the information in a text format on graphic display 26₃. Other formats may be used as desired and still remain within the scope of the present invention. Graphic displays similar to displays 26₁, 26₂ may be used during taxiing operations if desired. The identification of assigned gate C25 may convey gate assignment information to an air crew in an aircraft employing system 10 without requiring that an air crew member employ any special measures to preserve the gate assignment information, such as by printing or writing down the information. An embodiment of the invention may involve a user, such as an air crew member, initiating an action such as pushing a button or switch on a CDU or entering data using a keyboard or other input device to effect accepting the gate assignment information for display.

Prior art aircraft display systems presently present an airport map function and display, however the presently available airport map function does not display an assigned gate position. In an alternate embodiment of the system of the present invention entry of assigned gate information may be executed by a member of an air crew via a pilot control display unit or via a graphical display based interface unit. The airport map may then display an alpha numeric or iconic or symbolic designation of the assigned gate at some predetermined location on the airport map display or at the actual map location for the gate. The scale of the display may be determined as a function of the range scale for the navigation map selected on the pilot mode control panel.

The disclosure provides an increased situational awareness in air crews and reduces flight crew workload and potential for pilot error during a high workload phase of flight. An alternate implementation of the disclosure further provides calculation or display or calculation and display of a planned taxi route to the assigned gate position. The taxi route may be manually or automatically entered on the navigation map graphical display.

The disclosure may alternately permit a member of an air crew to manually enter the assigned gate position into the system via CDU (Crew Display Unit) entry or a graphical display-based interface. Further, the disclosure may alternately provide a capability to enter the assigned gate position via a tagged data link message.

Yet another alternate embodiment of the disclosure permits assigning a taxi route via a voice or data link with the assigned gate position being the terminus of the taxi route. Designation of the assigned gate position for departure may be employed to provide an origination point for an initial selection of taxiways for an assigned departure taxi route. Thus the assigned gate position may be employed for providing end points for departure and arrival taxi routing.

In all of its various embodiments, the disclosure provides members of an air crew with the improved situational awareness with respect to a planned route required for a return to a departure station gate position or taxi to an arrival station gate position.

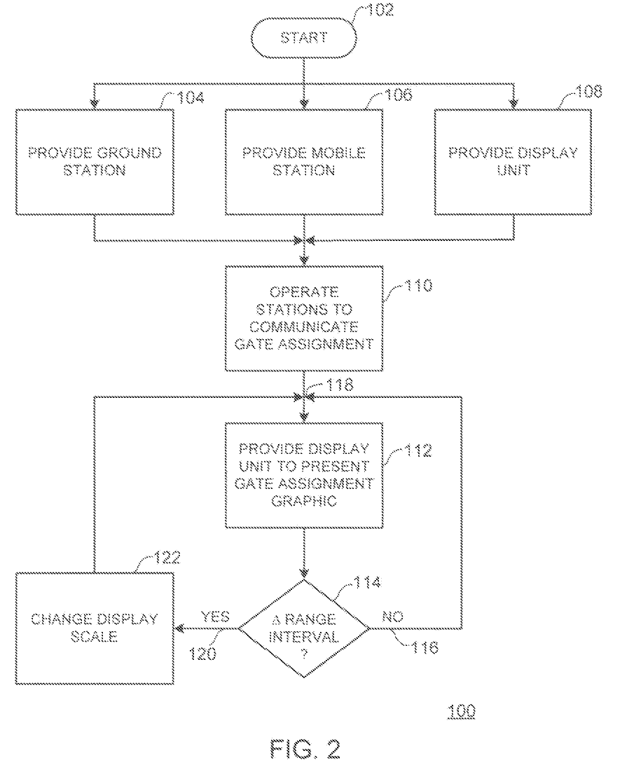

FIG. 2 is a flow chart illustrating the method of the disclosure. In FIG. 2, a method 100 for conveying a gate assignment at an airfield to an air crew in an aircraft begins at a START locus 102. Method continues with, in no particular order; (1) providing a ground station, as indicated by a block 104; (2) providing a mobile station carried with the aircraft, as indicated by a block 106; and (3) providing a display unit carried with the aircraft, as indicated by a block 108.

Method 100 continues with operating the ground station and the mobile station to effect communicatingly conveying the gate assignment between the ground station and the mobile station, as indicated by a block 110. Method 100 continues with operating the display unit to receive the gate assignment from the mobile station and present a graphic representation of the gate assignment to the air crew, as indicated by a block 112.

In a preferred embodiment, method 100 may continue by posing a query whether a predetermined change in range interval between the ground station and the mobile station has occurred, as indicated by a query block 114. If a predetermined change in range interval between the ground station and the mobile station has not occurred, method 100 proceeds via NO response line 116 to a juncture 118. Method 100 proceeds from juncture 118 as previously described. If a predetermined change in range interval between the ground station and the mobile station has occurred, method 100 proceeds via YES response line 120 and the display scale may be changed, as indicated by a block 122. Method 100 proceeds from block 122 to juncture 118 and continues from juncture 118 as previously described.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following

I claim:

1. A system for conveying information relating to a gate at a facility to a mobile unit;
the system comprising:
(a) a first station;
(b) a second station carried with said mobile unit; said second station being communicatingly coupled with said first station; and
(c) a display unit carried with said mobile unit; said display unit being coupled with said second station;
said first station communicating said information to said second station; said display unit receiving said information from said second station and presenting a graphic representation of said information.

2. A system for conveying information relating to a gate at a facility to a mobile unit as recited in claim 1 wherein said display unit receives said information in response to an action by a user in said mobile unit.

3. A system for conveying information relating to a gate at a facility to a mobile unit as recited in claim 1 wherein said graphic representation includes a representation of location of said gate with respect to features substantially surrounding said gate.

4. A system for conveying information relating to a gate at a facility to a mobile unit as recited in claim 1 wherein said information relates to location of said gate with respect to an air terminal and wherein said mobile unit is an aircraft.

5. A system for conveying information relating to a gate at a facility to a mobile unit as recited in claim 2 wherein said graphic representation includes a representation of location of said gate with respect to features substantially surrounding said gate.

6. A system for conveying information relating to a gate at a facility to a mobile unit as recited in claim 2 wherein said information relates to location of said gate with respect to an air terminal and wherein said mobile unit is an aircraft.

7. A system for conveying information relating to a gate at a facility to a mobile unit as recited in claim 5 wherein said information relates to location of said gate with respect to an air terminal and wherein said mobile unit is an aircraft.

8. A system for conveying a gate assignment at an airfield to an air crew in an aircraft;
the system comprising:
(a) a ground station;
(b) a mobile station carried with said aircraft; said mobile station being configured for communicative coupling with said ground station; and
(c) a display unit carried with said aircraft and coupled with said mobile station;
said ground station transmitting said gate assignment to said mobile station; said display unit receiving said gate assignment from said mobile station and presenting a graphic representation of said gate assignment to said air crew.

9. A system for conveying a gate assignment at an airfield to an air crew in an aircraft as recited in claim 8 wherein said display unit receives said gate assignment in response to an action by a user in said mobile unit.

10. A system for conveying a gate assignment at an airfield to an air crew in an aircraft as recited in claim 8 wherein said graphic representation includes a representation of location of said gate with respect to features substantially surrounding said gate.

11. A system for conveying a gate assignment at an airfield to an air crew in an aircraft as recited in claim 8 wherein said information relates to location of said gate with respect to an air terminal.

12. A system for conveying a gate assignment at an airfield to an air crew in an aircraft as recited in claim 9 wherein said graphic representation includes a representation of location of said gate with respect to features substantially surrounding said gate.

13. A system for conveying a gate assignment at an airfield to an air crew in an aircraft as recited in claim 9 wherein said information relates to location of said gate with respect to an air terminal.

14. A system for conveying a gate assignment at an airfield to an air crew in an aircraft as recited in claim 12 wherein said information relates to location of said gate with respect to an air terminal.

15. A method for conveying a gate assignment at an airfield to an air crew in an aircraft;
the method comprising:
(a) in no particular order;
(1) providing a ground station;
(2) providing a mobile station carried with said aircraft; and
(3) providing a display unit carried with said aircraft;
(d) operating said ground station and said mobile station to effect communicatingly conveying said gate assignment between said ground station and said mobile station; and
(e) operating said display unit to receive said gate assignment from said mobile station and present a graphic representation of said gate assignment to said air crew.

16. A method for conveying a gate assignment at an airfield to an air crew in an aircraft as recited in claim 15 wherein said display unit receives said gate assignment in response to an action by a user in said mobile unit.

17. A method for conveying a gate assignment at an airfield to an air crew in an aircraft as recited in claim 15 wherein said graphic representation includes a representation of location of said gate with respect to features substantially surrounding said gate.

18. A method for conveying a gate assignment at an airfield to an air crew in an aircraft as recited in claim 15 wherein said information relates to location of said gate with respect to an air terminal.

19. A method for conveying a gate assignment at an airfield to an air crew in an aircraft as recited in claim 16 wherein said graphic representation includes a representation of location of said gate with respect to features substantially surrounding said gate.

20. A method for conveying a gate assignment at an airfield to an air crew in an aircraft as recited in claim 16 wherein said information relates to location of said gate with respect to an air terminal.
